(19) United States
(12) Patent Application Publication
(10) Pub. No.: US 2023/0231628 A1
(43) Pub. Date: Jul. 20, 2023

(54) Optical Network Defragmentation Utilizing Mixed Integer Linear Programming Approaches

(71) Applicant: Meta Platforms, Inc., Menlo Park, CA (US)

(72) Inventors: Satyajeet Singh Ahuja, Saratoga, CA (US); Srivatsan Balasubramanian, Fremont, CA (US); Vinayak Dangui, Santa Clara, CA (US); Abishek Gopalan, San Jose, CA (US)

(21) Appl. No.: 17/576,576

(22) Filed: Jan. 14, 2022

(51) Int. Cl. H04B 10/27; H04J 14/02

(52) U.S. Cl. CPC H04B 10/27; H04J 14/0212

(57) ABSTRACT

The present disclosure provides systems and methods for operating optical networks and performing defragmentation operations. Embodiments include computer systems and computer program products comprising a computer readable storage and a processor. Upon receiving information indicative of a spectrum assignment on the optical network, a target entity associated with a set of optical channels and a potential spectrum path are identified. The target entity can be defragmented to enable the potential spectrum path, comprising reconfiguring at least one existing spectrum path associated with an optical channel in the set of optical channels. The potential spectrum path may then be reconfigured to a continuous and contiguous band of slice on at least one optical channel associated with the target entity.

### TECHNOLOGICAL FIELD

Exemplary embodiments of this disclosure may relate generally to optical network operations, and more particularly to methods, apparatuses and computer program products for optical network defragmentation.

### BACKGROUND

Optical networks may enable fast and efficient data communications between endpoints. As optical networks grow, and new spectra may be assigned within the network, different fiber routes may experience spectrum fragmentation. This may create bottlenecks when turning up capacity on existing fibers. One option to address fragmentation may be providing more fiber and using the new fiber to increase capacity. However, this approach is very time-consuming and labor intensive. It may take months to provide new fiber, since doing so may require extensive manual efforts across different parts of the network, and external factors, such as site vendors, space, and power availability. Due to restrictions, such as for example pandemic restrictions, it may not be possible for personnel to access the necessary sites to turnup fiber in a timely manner. And if significant delays are encountered, and capacity does not get delivered, there may be a network failure, which may affect end users.

Another option to address fragmentation is to manually create contiguous spectrum across different fibers to turnup capacity. However, manual identification and reconfiguration may be neither scalable nor efficient for large-scale networks. Accordingly, there exists significant challenges with regard to operating optical networks, creating fiber routes, and addressing fragmentation.

### BRIEF SUMMARY

Exemplary embodiments are described for operating an optical network and performing spectrum assignments, for example, using mixed integer linear programming (MILP) approaches. Systems and methods may include computer program products including a computer readable storage medium and a processor. The computer-executable program code instructions may include program code instructions configured to receive data and analyze the received data. Moreover, the computer-executable program code instructions may include program code instructions configured to execute one or more methods discussed herein.

According to some exemplary embodiments, systems and methods may include receiving information indicative of a request to assign a spectrum on the optical network, wherein the optical network includes a plurality of optical channels, and the spectrum includes information deliverable via one or more nodes or fibers on at least one optical channel, determining a target entity associated with a set of optical channels and a potential spectrum path, defragmenting the target entity to enable the potential spectrum path, wherein defragmenting includes reconfiguring at least one existing spectrum path associated with an optical channel in the set of optical channels, and reconfiguring the potential spectrum path to associate and/or reconfigure a continuous and contiguous band of slices on each optical channel associated with the target entity. Accordingly, embodiments enable spectrum assignment on paths that could not otherwise allow such admission.

In one example embodiment, determining the target entity may include analyzing a current network utilization to identify one or more target entities, analyzing defragmentation production for each target entity based on one or more defragmentation factors, and determining the target entity based on the defragmentation production analysis. One or more target entities may be associated with a highest network utilization level, for example. Defragmentation factors may include at least one of: a network capacity, a number of reconfigurations, and a defragmentation type. Nodes may include at least one of: a reconfigurable wavelength selective switch (W) or a reconfigurable add/drop switch (AD).

In another example embodiment, reconfiguring the at least one existing spectrum path may adhere to a set of constraints, including but not limited to one or more of a rail constraint, and Add/Drop constraint, or a slice constraint. The target entity may be at least one of: a set of Shared Risk Link Groups (SRLGs), a set of rails, a set of Add/Drop nodes, a set of slices, or a chosen set of optical channels.

Moreover, reconfiguring at least one existing spectrum path may include switching to a new (AD) card, switching to a new spectrum, switching to a new fiber in a same or different SRLG), introducing new connectivity between fibers and an AD card (e.g., W-AD connectivity), and introducing a new fiber to fiber connectivity. The AD card may utilize wavelength selective switching and a transponder to add/drop a new spectrum path. In some exemplary embodiments, the new spectrum path may be an optical channel. In some exemplary embodiments, at least one of the fiber to fiber or W-AD connectivity may include (W) for fibers. Accordingly, embodiments may reduce or minimize optical network reconfigurations, and thereby reduce disruptions to existing deployed services.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a diagram of an optical network in accordance with an exemplary embodiment.

FIG. 2 is a diagram of an optical channel in accordance with an exemplary embodiment.

FIG. 3A illustrates an example node architecture in accordance with an exemplary embodiment.

FIG. 3B illustrates a defragmentation example in accordance with an exemplary embodiment.

FIG. 4A illustrates an example optical channel and spectrum path in accordance with an exemplary embodiment.

FIG. 4B illustrates an updated optical channel in accordance with an exemplary embodiment.

FIG. 5 illustrates a flowchart of spectrum assignment in accordance with an exemplary embodiment.

FIG. 6 illustrates a flow chart of target entity determination in accordance with an exemplary embodiment.

FIG. 7 is a diagram of an exemplary computer system in accordance with an exemplary embodiment.

FIG. 8 shows a block diagram of a distributed computer system, in which various aspects may be implemented, according to some exemplary embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein “defragment,” “defragmenting,” or the like may, for example, include reconfiguring at least one existing spectrum path associated with an optical channel in a set of optical channels.

As referred to herein, “truck roll(s)” may refer to personnel (e.g., a field engineer) physically visiting a site (for example in their vehicle) and being physically present at the site to manipulate (e.g., move around, work on, repair, etc.) network equipment, and/or alter cabling (e.g., optical channels, spectrum, fibers, cables, etc.) within, or associated with, the site.

References in this description to “an embodiment”, “one embodiment”, or the like, may mean that the particular feature, function, or characteristic being described is included in at least one embodiment of the present invention. Occurrences of such phrases in this specification do not necessarily all refer to the same embodiment, nor are they necessarily mutually exclusive.

It is to be understood that the methods and systems described herein are not limited to specific methods, specific components, or to particular implementations. It is also to be understood that the terminology used herein is for the purpose of describing particular embodiments only and is not intended to be limiting.

Systems and methods are disclosed for operating optical networks and defragmenting spectrums. Embodiments may include applying mixed integer linear programming approaches, such as providing a minimum number of channels to be shifted and/or moved, in order to incorporate new spectrum capacity. Such approaches may be particularly beneficial when network facilities and physical hardware may be restricted and/or may not be easily accessible.

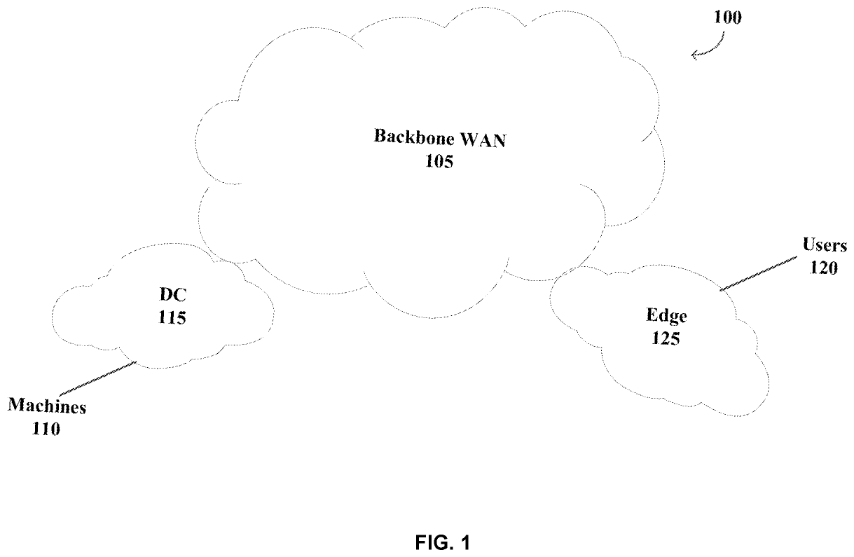

FIG. 1 illustrates a diagram of a wide area network (WAN) 100, and the relationship between machines 110, hosted in data centers (DCs) 115, and user devices 120 on the network edge 125. Server farms may host a plurality of computing platforms and services, may be housed in one or more data centers (DCs) 115 and Point of Presence (POP) sites, connected over a large, wide area optical network.

The backbone 105 (also referred to herein as backbone WAN) of the WAN 100 may include Internet protocol (IP) routers connected over an optical network such as, for example, a wide area optical network. The optical network may further include a plurality of optical nodes spread over a vast geographical area connected by optical fibers.

According to some exemplary embodiments, the user device 120 and/or machines 110 may include one or more computing devices, such as for example, a server(s) and memory device(s) (e.g., data store(s)), capable of receiving user input as well as transmitting and/or receiving data via the network 100. In one exemplary embodiment, a user device 120 may be a computer system, such as a desktop, a laptop computer, or a smart tablet. Alternatively, a user device 120 may be a device having computer functionality, such as a personal digital assistant (PDA), a mobile telephone, a smartphone or another suitable device. The user device 120 may be configured to communicate with the backbone WAN 105 via the edge 125, and ultimately to the machines 110 through the data center(s) 115.

The backbone WAN 105 may include any combination of local area and/or wide area networks, using both wired and/or wireless communication systems. In one exemplary embodiment, the backbone WAN 105 may use standard communications technologies and/or protocols. In exemplary embodiments, WAN sites may be connected by fiber and may run wavelength division multiplexing (WDM). For example, the network may include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 160 may be represented using any suitable format, such as, for example, hypertext markup language (HTML) or extensible markup language (XML). In some exemplary embodiments, all or some of the communication links of the network 160 may be encrypted using any suitable technique or techniques. One or more external machines 110 may be coupled to the backbone WAN 105 to communicate with the user device 120.

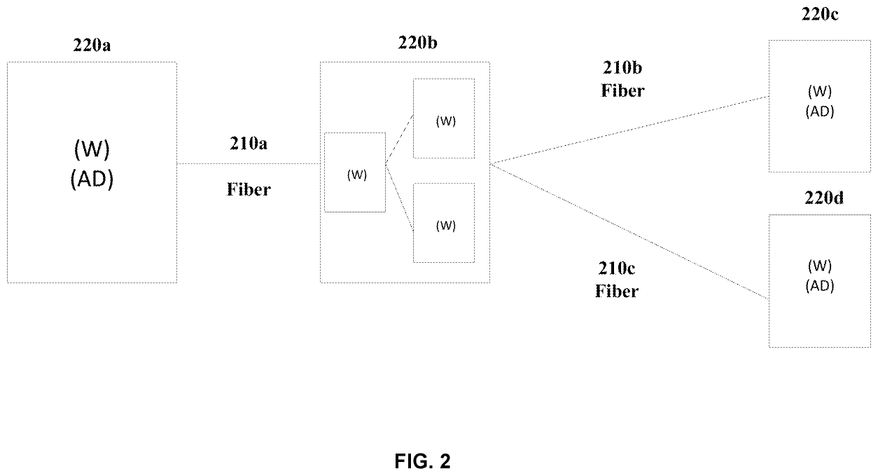

FIG. 2 illustrates connections between sites 220 a-d by fibers 210 a-c. Each network element may include one or more a reconfigurable wavelength selective switch (W) and a reconfigurable add/drop switch (AD). (W)s may generally be optical elements that allow optical signals to be switched through different optical nodes that form part of the optical backbone. (AD)s may generally be optical elements that allow an optical signal to be added and/or dropped at a site. Fibers 210 a-c may be an optical medium that connects (AD)s and (W)s at a site, and may allow connections between the elements over a wide area network.

As illustrated in FIG. 2, sites may include a (AD) and a (W), as in 220a, 220c, and 220d. A site, such as site 220b, may include a plurality of (W)s, each connected via fibers. The set of (W)s at site 220b may be connected via fibers 210b and 210c, to sites 220c, and 220d, respectively.

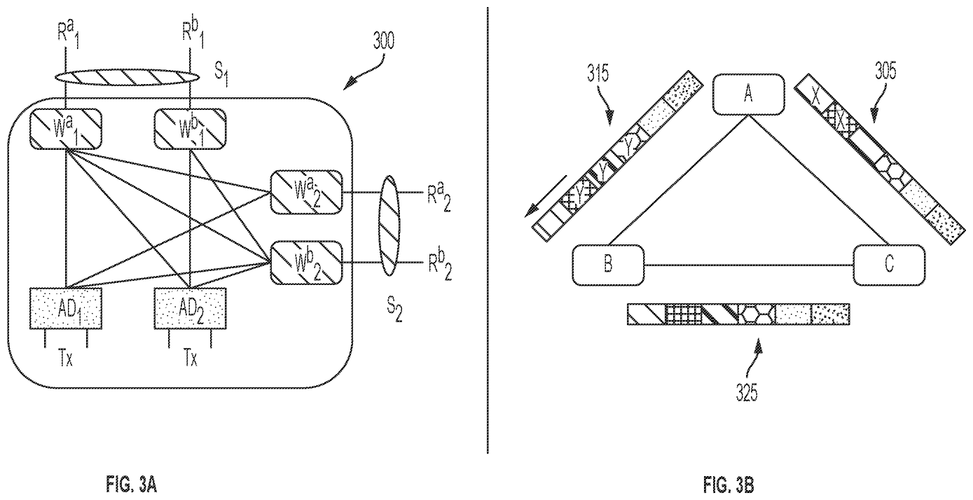

FIG. 3A illustrates an example node architecture in accordance with exemplary embodiments, and FIG. 3B illustrates a defragmentation example in accordance with exemplary embodiments. In optical networks, a plan of capacity may be built into the backbone to handle traffic forecasts, and account for events that may occur, such as network failures. The plan of capacity may be established between IP routers, which in turn may be carried over channels in the optical network.

In particular, based on a network traffic forecast, a capacity plan may be generated by a multilayer network planning tool that protects the backbone under different failure scenarios in the IP layer. The capacity plan may be realized as an IP adjacency of specified bandwidth connecting routers along a well defined Shared Risk Link Groups (SRLG) path. In examples, SRLGs may allow the user to establish a backup secondary path or reroute which is disjoint from the original, primary path.

The IP services are may be activated using optical services which in turn may be carried over optical channels. The optical channel is reconfigured to a continuous and contiguous band of slices (e.g., 6.25 GHz chunks) on every SRLG along the path. Spectrum in the optical network may be split into 6.25 GHz slices, however it will be appreciated that slices of other sizes may be implemented, according to design considerations, and the WAN onto which techniques are being implemented.

FIG. 3A provides an example node architecture illustrating intra node connections. In examples, the node architecture could be a at a domain controller (DC) site, a point of presence (POP), or any wide area network (WAN). The node has two SRLG degrees (S₁ and S₂), each having two fibers (Rails a and b). The network has two types of cards: W (e.g., wavelength selective switching (W) meant for switching across fibers) and AD (e.g., (W) and transponders meant for add/drop). The number of ports on both cards may be limited (Wₘₐₓ), i.e., a full mesh within a node may not be possible. As such, a spectrum may be unable to switch from fibers R^{b}₁ to R^{a}₂ since the card W^{b}₁ is not connected to W^{a}₂. Likewise, spectrum from R^{a}₂ may be unable to drop on card AD₂ and spectrum from R^{b}₁ may be unable to drop on card AD₁ due to lack of full mesh connectivity. An additional constraint may be that if a slice s is used by AD₁ on a rail (e.g., R^{a}₁), the same slice may be unable to be dropped by AD₁ from other rails.

In various exemplary embodiments, spectrum assignment may utilize a production optical pipeline with an objective of minimizing overall future network level blocking. As discussed herein, given the constant evolution of networks, and the changes in traffic and technologies over time, spectrum may get fragmented in the field, and a continuous and contiguous spectrum may not always be available end to end along a given SRLG path.

Accordingly, exemplary embodiments disclosed herein may be configured to target portion of the network and reconfigure a small set of installed optical channels in the production network, with the goal of unblocking new optical spectrum that is continuous and contiguous. As such, fragmentation problems may be addressed, without the need to wait an extended period of time, like in new route builds.

FIG. 3B further illustrates this concept in a defragmentation example comprising 3 connected rails. In the example of FIG. 3B, each rail may have a maximum of 6 spectrum slices, with rails X and Y being presently installed. For a new connection to be installed, each slice may need to be contiguous (e.g., adjacent on the rail), and continuous (e.g., placed on similar positions on each rail).

Continuing the example of FIG. 3B, if a new connection, e.g., Connection Z (not shown) is requested to be implemented and requires 3 slices along the SRLG path A-B-C, its placement may be limited, if not impossible. SRLG A-C may be unable to be used since any placement on the rail would not be contiguous with SRLG A-B, which does not have 3 continuous slices available in the example of FIG. 3. An exemplary approach may be to reconfigure Y to shift one slice to the end, thereby creating space for Connection Z's 3 slices to be admitted on the rail.

Moreover, although reconfigurations in the field may be complex operations and may be associated with risks (e.g., a network failure), these challenges may be addressed by the exemplary embodiments formulating the solution of a MILP formulation, with an objective to maximize newly admitted capacity, minimize field reconfigurations, and avoid manual reconfiguration or repair, where possible. Exemplary embodiments may utilize MILP techniques to reduce a number of reconfiguration operations. Reconfiguration reduction may further improve efficiency by reducing shuffling operations, and the possibility of field errors that may occur through such operations. Such reconfiguration and shuffling operations may otherwise be discouraged or left unaddressed since the possibility of field errors may increase when there are an increased number of field operations. Truck rolls, for example, may also be reduced. Truck rolls may occur in instances in which a field engineer or other user manually repairs and/or reconfigures a site, for example, to move around network gear, alter cabling at the site, and/or the like.

Shuffling operations, which may be required to make the defragmentation, may require a remote configuration, which may not require a physical presence, or a physical reconfiguration, which typically requires a physical presence. The former changes may be easier to implement and less error prone since they may be done by software. The latter may result in unintended consequences if the field engineer or individual introduces human errors during deployment activities. It may be extremely difficult, if not impossible, to fully eliminate risks of human errors during such activities.

Some examples of remote configuration operations may include switching spectrums and switching to different fibers within the same SRLG duct. Some examples of physical reconfigurations may include switching to a different add/drop module and adding new W-W, W-AD connectivity within a site.

To make MILP scale, a target entity may be defined to be defragmented. The target entity may be associated with the set of optical channels that are candidates to be defragmented. In examples, the target entity may be a set of SRLGs, a set of rails, a set of Add/Drop nodes, a set of slices, and/or a combination of the these. The target entity may also be chosen based on network utilization.

Some exemplary embodiments may consider reconfiguring a subset of optical channels associated with the target entity to admit new channels that may otherwise be blocked. For instance, on a blocked channel, the target entity with a highest utilization may be identified and channels riding the SRLG may be candidates for defragmentation. There may be different types of reconfigurations possible in the field (e.g., a site, a physical location) and may differ in whether they may require a truck roll. For instance, changing the spectrum of a channel, or switching the spectrum to a different rail within the same target entity (e.g., with an installed fiber to fiber card connectivity) may be done through remote configurations. However, operations like switching to a new AD card, switching to a new spectrum, switching to a new fiber in the same or different SRLG, or introducing a new W-AD or fiber to fiber connectivity associated with a channel(s) may require site visits. Exemplary embodiments described herein may take in an optical topology, blocked channels, the entity to be defragmented, and allowed reconfiguration type(s) as one or more inputs. The exemplary embodiments may provide newly admitted channels and the reconfiguration required in the field to achieve determination of candidates for defragmentation.

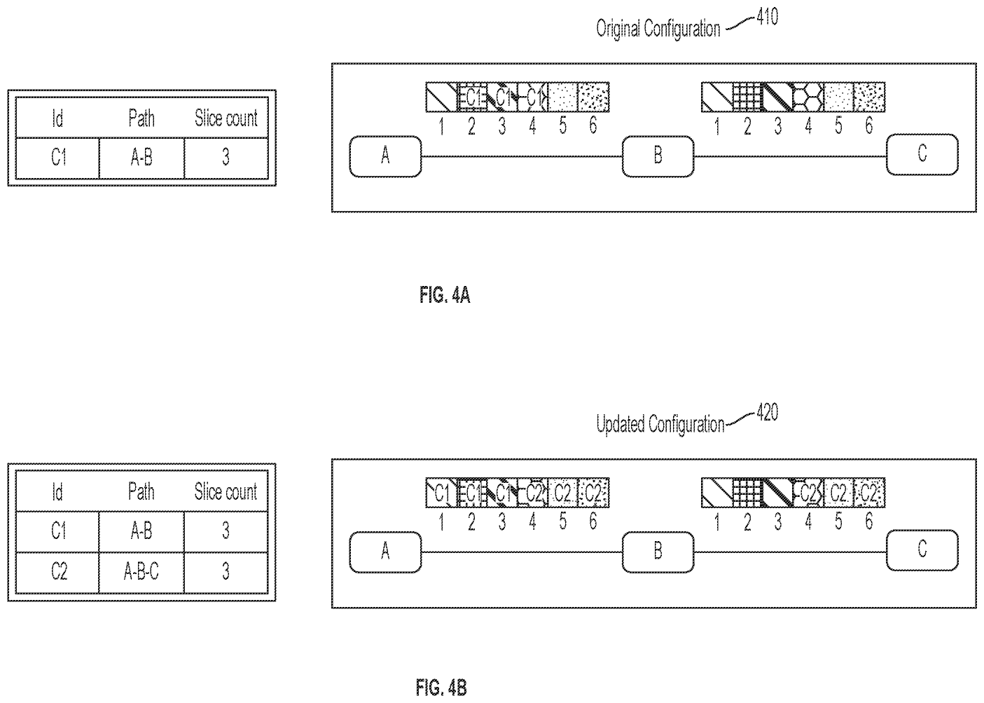

FIGS. 4A-B illustrate another defragmentation and reconfiguration example in accordance with exemplary embodiments discussed herein. Example embodiments may reconfigure a set of one or more existing optical channels to unblock new optical spectrum that is continuous and contiguous.

FIGS. 4A and 4B illustrate optical channels between nodes A, B, and C, with each optical channel including 6 slices for purposes of illustration and not of limitation. As shown in FIG. 4A a first spectrum, with an identifier (ID) of C1 is set on path A-B. C1 may have a slice count of 3 in this example. In the original configuration 410, spectrum C1 may be provided on slices 2, 3, and 4.

FIG. 4B illustrates the introduction of a new spectrum C2, to be provided on path A-B-C and having a slice count of three (3) slices. In the original configuration 410 of FIG. 4A, there is no availability on path A-B-C for spectrum C2 that are both continuous and contiguous. For example, in FIG. 4A, on path A-B, there may not be room/space for 3 contiguous slices, since only slices 1, 5, and 6 are available. Any contiguous placement on path B-C of FIG. 4A such as, for example, contiguous slice sets of 3 slices as [1, 2, 3], [2, 3, 4], [3, 4, 5], and [4, 5, 6] may not have a corresponding slice set on path A-B in the example since only slices 1, 5, and 6 are available and slices for C1 are on [2, 3, 4]. Thus, the path A-B-C may not be continuous.

Exemplary embodiments described herein, however, may provide for an updated configuration, such as updated configuration 420, which may identify a target entity and reconfigure one or more existing optical channels to allow assignment of additional spectra. As illustrated in FIG. 4B, spectrum C1, originally placed on slices 2, 3, 4 as shown in FIG. 4A, has been shifted over to slices 1, 2, and 3, thereby unblocking path A-B and providing a continuous and contiguous option for spectrum C2 having 3 slices. After defragmentation and reconfiguration of spectrum C1, spectrum C2 may be contiguously provided on slices 4, 5, 6 on path A-B, and continues on the same set of corresponding slices 4, 5, 6 on path B-C.

In the absence of continuity constraints, an electrical regeneration may be necessary. Electrical regenerations may be very costly, may require space and/or power which may not be feasible, and may require an optical channel to be optically converted from one spectrum to another optically. However, a stable commodity technology for such operations may not currently exist today.

Moreover, contiguity constraints may be necessary due to IP port rates typically being in increments of 100G/400G. Optical technologies may attempt to pack this IP data into the smallest spectrum width possible, while still maintaining certain minimum widths due to laws of physics and attempts to improve packing efficiency.

As discussed herein, MILP approaches may use a branch-and bound technique to determine one or more target entities. In an example, a branch-and-bound algorithm (e.g., implemented by shuffler module 714) may comprise a systematic enumeration of candidate solutions and utilize a state space search. The set of candidate solutions may be viewed as forming a rooted tree with the full set at the root. A branch-and-bound algorithm may explore branches of this tree, which represent subsets of the solution set. Before enumerating the candidate solutions of a branch, the branch may be checked against upper and lower estimated bounds on the optimal solution, and may be discarded if it cannot produce a better solution than the best one found so far by the algorithm.

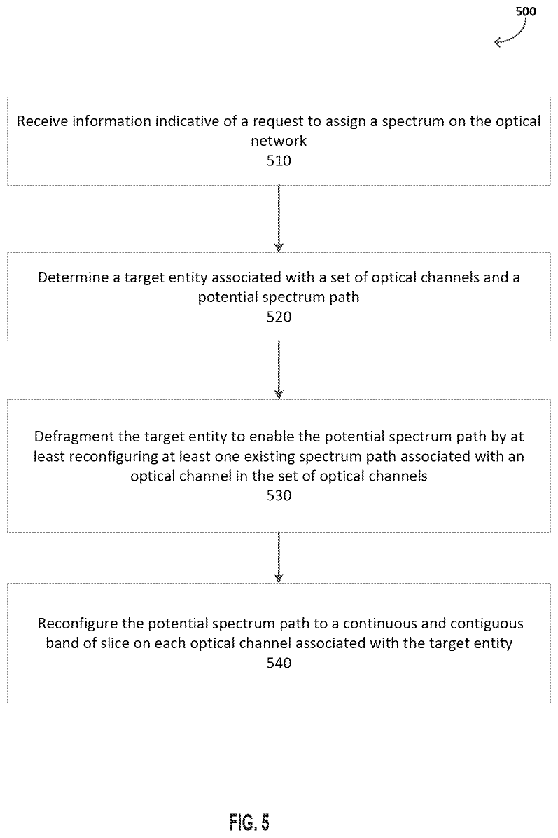

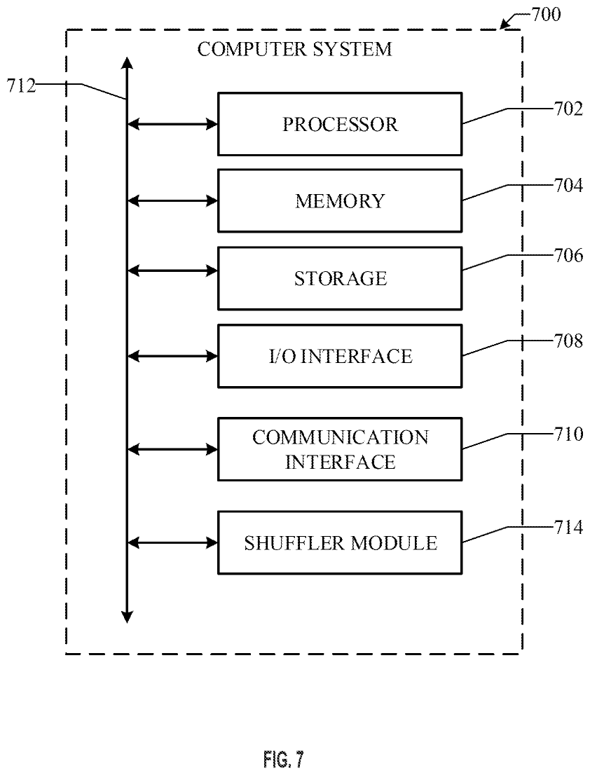

FIG. 5 illustrates an example method 500 for operating optical networks and performing defragmentation and reconfiguration operations in accordance with exemplary embodiments. In exemplary embodiments, an apparatus (e.g., a shuffler module 714 of FIG. 7) may receive information indicative of a request to assign a spectrum on an optical network, at operation 510. The optical network may include a plurality of optical channels, and the spectrum may include information deliverable via one or more nodes or fibers on at least one optical channel.

Optical channels, as described herein may typically be set up from a first node to a second node along a fiber path and any optical elements along the way such as, for example, (W)s and (AD)s. As described herein, the set of slices along the path may need to be continuous and contiguous along the path.

After receiving information indicative of a request to assign the spectrum, an apparatus (e.g., shuffler module 714) may determine a target entity associated with a set of optical channels and a potential spectrum path, at operation 520. In examples, a spectrum path may be an optical channel, and may be a new optical channel distinct from any existing optical channels. In some example embodiments, a target entity may include at least one of: a set of Shared Risk Link Groups (SRLGs), a set of rails, a set of Add/Drop nodes, or a set of slices.

In some exemplary embodiments an apparatus (e.g., shuffler module 714) may defragment the target entity to enable the potential spectrum path, at operation 530. Defragmenting may include reconfiguring at least one existing spectrum path associated with an optical channel in the set of optical channels. In some exemplary embodiments, reconfiguring the spectrum path may require adherence to a set of constraints, as described below. Constraints may include, but are not limited to a rail constraint, an Add/Drop (AD) constraint, or a slice constraint.

In some example embodiments, reconfiguring at least one existing spectrum path may include switching to a new Add/Drop (AD) card, switching to a new spectrum, switching to a new fiber, which may be in a same or different SRLG rail in a same or different SLRG duct, introducing a new connectivity between fibers and an AD card (W-AD connectivity), and introducing a new fiber to fiber connectivity. The AD, for example, card may utilize wavelength selective switching (W) and a transponder to reconfigure existing spectrum path. In other examples, at least one of the fiber to fiber or W-AD connectivity comprises wavelength selective switching for fibers to reconfigure existing spectrum path. The potential spectrum path may then be reconfigured by an apparatus (e.g., shuffler module 714) to a continuous and contiguous band of slices on each optical channel associated with the target entity, at operation 540.

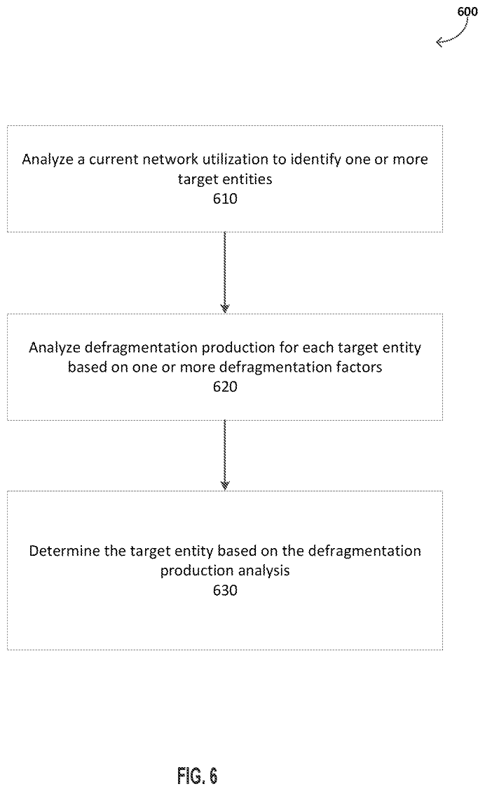

FIG. 6 provides a flowchart illustrating an example process for determining the target entity 600. An apparatus (e.g., shuffler module 714) may analyze a current network utilization to identify one or more target entities, at operation 610, and may analyze defragmentation production for each target entity based on one or more defragmentation factors, at operation 620. Defragmentation factors may include, but are not limited to, one or more of a network capacity, a number of potential reconfigurations, and/or a defragmentation type(s).

At operation 630, an apparatus (e.g., shuffler module 714) may determine the target entity based on the defragmentation production analysis. In some exemplary embodiments, the one or more identified target entities may be based on a network utilization level. For example, entities (e.g., channels, spectrum, etc.) with the greatest network utilization level may be identified as a target entity. In exemplary embodiments, target entities may be selected based on a threshold network utilization level. The threshold network utilization level may be a predetermined utilization level, as discussed below. In some exemplary embodiments, an apparatus (e.g., shuffler module 714) may select the target entities.

To determine a target entity, an apparatus (e.g., shuffler module 714) may identify one or more network elements that the spectrum path may interact with. Spectrum paths may interact with switching devices and/or add/drop devices. Any subset of these devices may need to be defragmented to make space for new channels. To identify the subset, an apparatus (e.g., shuffler module 714) may determine a fraction of the capacity utilized by one or more devices, and a threshold(s) percentage of utilization of devices above or below such threshold(s) may be considered for defragmentation. Alternatively, an apparatus (e.g., shuffler module 714) may consider a fixed bucket of slices and/or optical channels falling within a specific frequency window (e.g., the 100 lowest frequencies, frequencies falling within a window of frequencies, etc.) in the whole available band of spectrum, arranged, for example, in ascending or descending order, to determine defragmentation.

Expanding upon defragmentation techniques according to exemplary embodiments, any or all of the following may be provided as inputs to an apparatus (e.g., shuffler module 714) to facilitate defragmentation: optical topology, optical channel capacity that is considered blocked due to contention, an entity to be defragmented, a user specified set of (AD)s, a user specified set of SLRG, a user specified set of rails. In an exemplary embodiment, an apparatus (e.g., shuffler module 714) may utilize one or more of these inputs to determine a projected defragmentation scenario, a scope of changes to be considered for defragmentation, including but not limited to, one or more of the following: a switch only spectrum (e.g., requiring only remote reconfiguration), a switch to a different fiber or rail in the same SLRG duct (e.g., requiring only remote reconfiguration), a switch to a different add/drop module, an addition of an intra site fiber to admit more channels, and/or procurement of a bridge fiber within a site to admit more channels.

Defragmentation techniques utilized by an apparatus (e.g., shuffler module 714) may further use one or more of the following approaches: formulation of a defragmentation problem as a MILP formulation with an objective to maximize admitted capacity; and applying constraints including, but not limited to, spectrum continuity, contiguity, spectrum co-routing, W/AD degree, intra node and contention constraints and any other suitable constraints.

Defragmentation outputs, that may be output by an exemplary apparatus (e.g., shuffler module 714) may include, but are not limited to, one or more of the following: a number of optical channels admitted, the exact reconfiguration that may be required in the field, or the migration sequence required to go from production to a target topology that may include incorporated reconfigurations, or admission of the new spectrum.

Defragmentation goals that may be employed by an apparatus (e.g., shuffler module 714) may include, but are not limited to, one or more of the following: admitting blocked capacity to the maximum extent possible, minimizing changes and channels carried on the scoped set of spectrum to be reconfigured (if any), and avoiding truck roll changes unless absolutely necessary.

It will be appreciated that defragmentation and reconfiguration techniques may conform to one or more constraints. With regards to the example constraints and MILP formulations described herein, the followings symbols provided in Table 1 may be utilized.

TABLE 1
Symbols for Constraints and MILP Formulations

| | | | |
|---|---|---|---|
| S | List of all available slices in a rail of SRLG | Mᵢ | Ordered list of SRLGs in the |
| | | | path of channel i |
| D | blocked and defragment candidate | Rₘ_{ₖ} | List of rails in duct mₖ, where |
| | channels | | mₖ is SRLG in hop k |
| R | List of fiber rails | Mᵢ | List of mₖ, for every hop k |
| | | | traversed by channel I |
| Uₙ | List of rails incident @ node n | Vᵢ | Union of rails Rₘ_{ₖ} for every hop |
| | | | k of channel i |
| Xⁿ_{c,r} | 1 iff AD c patches to rail r installed at node n | X^{r}ᵢ | l iff rail r is assigned to |
| | | | channel i |
| Xⁿᵣ_{₁}_{,r2} | 1 iff rail r₁ to r₂ patch is installed at | Y^{c}ᵢ | 1 iff AD chassis c is assigned to |
| | node n | | channel i |
| C′ₙ | List of AD chassis @ node n | Z^{s}ᵢ | 1 iff spectrum starting with s is |
| | | | assigned to channel i |
| C^{x}ᵢ | all ADs for channel i on src(x = o) and | A1^{s,r}ᵢ | 1 iff spectrum s is assigned to |
| | dst(x = d) | | channel i on rail r |
| Dₙ | List of channels sourcing or sinking at | A2^{s,c}ᵢ | 1 iff spectrum s is assigned to |
| | node n | | channel i on AD c |
| i | i^{th}ith channel in D. Traverses SRLG | A3ⁿ_{c,r} | 1 iff AD chassis c connects to |
| | hops 1, 2, .. hᵢ | | rail r at node n |
| w | number of slices required by channel i | A4ⁿᵣ_{₁}_{,r}_{₂} | 1 iff rail r1 connects to rail r2 at |
| | | | node n |

The following list provides example constraints and example MILP formulations utilized by an exemplary apparatus (e.g., shuffler module 714) with the defragmentation techniques and reconfiguration operations as described herein.

Rail Assignment: Each channel(s) may be assigned one rail along each SRLG of the path.

$${\sum }_{s ∈ S} {\sum }_{r ∈ {R}_{{m}_{k}}} A {1}_{i}^{S , r} < = w , ∀ i ∈ D , ∀ k ∈ 1 , 2 , … {h}_{i} \qquad ( 1 )$$

Rail Contention: No two channels may be assigned the same spectrum on a given rail.

$${\sum }_{i} A {1}_{i}^{s , r} \leq 1 ∀ r ∈ {V}_{i} , ∀ s ∈ S \qquad ( 2 )$$

Rail CoRouting: Every slice belonging to a channel may be co-routed on the same rail.

$$w * {X}_{i}^{r} < = {\sum }_{s} A {1}_{i}^{s , r} , ∀ r ∈ {V}_{i} , ∀ i ∈ D \qquad ( 3 )$$

$${\sum }_{r ∈ {R}_{{m}_{k}}} {X}_{i}^{r} = {\sum }_{s} {Z}_{i}^{s} , ∀ i ∈ D , ∀ k ∈ 1 , 2 , … {h}_{i} \qquad ( 4 )$$

Rail Spectrum Continuity: Every channel may be assigned the same spectrum in every rail of the path.

$${\sum }_{r ∈ {R}_{{m}_{k}}} A {1}_{i}^{s , r} = {\sum }_{r ∈ {R}_{{m}_{k + 1}}} A {1}_{i}^{s , r} ∀ i ∈ D , ∀ s ∈ S , ∀ k ∈ 1 , 2 , … h - {1}_{i} \qquad ( 5 )$$

Rail Intra node: A channel going through two consecutive fibers at a node may counts as a port in a respective wavelength selective switch.

$$w * A {1}_{{r}_{1} , {r}_{2}}^{n} \geq {\sum }_{s ∈ S} A {1}_{i}^{s , {r}_{1}} + {\sum }_{s ∈ S} A {1}_{i}^{s , {r}_{2}} - w ∀ i ∈ {D}_{n} , ∀ {r}_{1} , {r}_{2} ∈ {U}_{n} , \qquad ( 6 )$$

$${\sum }_{{r}_{2} ∈ {U}_{n} {r}_{1} \neq {r}_{2}} A {4}_{{r}_{1} , {r}_{2}}^{n} + {\sum }_{r = {r}_{1} , c ∈ {C}_{n}^{′}} A {3}_{c , r}^{n} < = w s {s}_{max} , ∀ {r}_{1} ∈ {U}_{n} , ∀ n \qquad ( 7 )$$

AD Assignment: All slices of the channel may be carried by at least one AD card.

$${\sum }_{s ∈ S} {\sum }_{c ∈ {C}_{i}} A {2}_{i}^{s , c} < = w , ∀ i ∈ {D}_{n} \qquad ( 8 )$$

AD Contention: No two channels may be assigned the same spectrum on a given AD chassis.

$${\sum }_{i} A {2}_{i}^{s , c} \leq 1 ∀ c ∈ {C}_{i} , ∀ s ∈ S \qquad ( 9 )$$

AD Spectrum Continuity: Every channel may be assigned the same spectrum on the first SRLG and AD card.

$${\sum }_{c ∈ {C}_{i}^{x}} A {2}_{i}^{s , c} = {\sum }_{r ∈ {R}_{{m}_{1}}} A {1}_{i}^{s , r} , ∀ x ∈ [ o , d ] , ∀ i ∈ {D}_{n} , ∀ s ∈ S \qquad ( 10 )$$

AD CoRouting: Every slice belonging to a channel may be co-routed on the same AD chassis.

$$w * {Y}_{i}^{c} < = {\sum }_{s} A {2}_{i}^{s , c} , ∀ c ∈ [ {C}_{i}^{o} , {C}_{i}^{d} ] , ∀ i ∈ D \qquad ( 11 )$$

$${\sum }_{c ∈ {C}_{i}^{x}} {Y}_{i}^{c} = {\sum }_{s} {Z}_{i}^{s} , ∀ i ∈ D , ∀ x ∈ [ o , d ] , ∀ {m}_{k} ∈ {M}_{i} \qquad ( 12 )$$

AD Intra node: Every channel going through a AD chassis and rail may count towards a port in an AD chassis.

$$w * A {3}_{c , r}^{n} \geq {\sum }_{s ∈ S} A {1}_{i}^{s , r} + {\sum }_{s ∈ S} A {2}_{i}^{s , c} - w ∀ i ∈ {D}_{n} , ∀ c ∈ {C}_{n}^{′} , ∀ r ∈ {U}_{n} \qquad ( 13 )$$

$${\sum }_{r} A {3}_{c , r}^{n} < = w s {s}_{max} , ∀ c ∈ {C}_{n}^{′} , ∀ n \qquad ( 14 )$$

Slice Contiguity Assignment: Every slice that is allocated to the channel should be contiguous.

$$w * {Z}_{i}^{s} < = {\sum }_{j = 0 … {wr}_{1}} {\sum }_{∈ {m}_{1}} A {1}_{i}^{s + j , {r}_{1}} , ∀ s ∈ S , ∀ i ∈ {D}_{n} \qquad ( 15 )$$

$${\sum }_{s} {Z}_{i}^{s} < = 1 ∀ i ∈ D \qquad ( 16 )$$

Objective: α, β, γ, θ, κ, μ are weights. sₒ, rₒ, and cₒ are spectrum, rail and AD allocated if channel i is installed.

$$α {\sum }_{i} A {1}_{i}^{s , r} - β {\sum }_{s , s ∉ {s}_{o}} {Z}_{i}^{s} - γ {\sum }_{r , r ∉ {r}_{o}} {X}_{i}^{r} - θ {\sum }_{c , c ∉ {c}_{o}} {Y}_{i}^{C} - κ {\sum }_{r 1 , r 2 , n , {X}_{{r}_{1}}^{n} , {r}_{2} = 0} A {4}_{{r}_{1} , {r}_{2}}^{n} - μ {\sum }_{r 1 , r 2 , n , {X}_{c , r}^{n}} A {3}_{c , r}^{n} \qquad ( 17 )$$

Results

Table 2 may provide defragmentation production scenarios, determined by an apparatus (e.g., shuffler module 714) of the exemplary embodiments. A production network in accordance with exemplary embodiments may have hundreds (100s) of nodes and several 100s of SRLGs. An apparatus (e.g., shuffling module 714) implementing aspects of the exemplary embodiments may be tuned to an aggregate of slices (e.g., determined as a factor of installed channel widths) for scale and may provide results within a short time period (e.g., an hour) in some instances. During an implementation, by an apparatus (e.g., shuffler module 714), in some exemplary embodiments several IP adjacencies may be required to be turned up to prevent production risk due to traffic surge, but which may have been blocked due to inability to build new fiber rails. Table 2, described below, provides several examples where capacities may have been unblocked in the production network through defragmentation of selected entities. In some exemplary embodiments, these unblocked capacities were enabled with remote reconfigurations due to mobility restrictions. An apparatus of the exemplary embodiments (e.g., shuffler module 714) may be integrated with the production optical pipeline to defragment a targeted portion of the optical network (e.g., with truck rolls, where necessary) to onboard blocked capacity and prevent network risk.

TABLE 2
Defragmentation production scenarios

| Route | Capacity | Reconfigurations | Defrag Type |
|---|---|---|---|
| 1 | 700G | 3 | 1 SRLG |
| 2 | 600G | 15 | 1 SRLG |
| 3 | 3T | 30 | 2 SRLGs |
| 4 | 600G | 10 | 1 AD card |
| 5 | 1T | 15 | 3 AD Cards |

Table 3 illustrates results of an optical network defragmentation performed in accordance with exemplary embodiments described herein. For purposes of illustration and not of limitation, Table 3 shows that for a route ASH-ATN associated with a spectrum of 800G that an apparatus such as for example the shuffler module 714 made 3 configuration changes (e.g., defragmenting) to the spectrum path (for example to reshuffle the spectrum and unblock the path to accommodate additional slices of spectrum in a continuous and contiguous fashion).

TABLE 3
Defragmentation Savings in Production
Topology

| Route | Capacity | Changes | Defrag Type |
|---|---|---|---|
| ASH-ATN | 800G | 3 | SLRG |
| ASH-FTW | 600G | 15 | SLRG |
| EWR-STL | 600G | 10 | AD |
| FRC-STL | 3T | 30 | MULTI_SLRG |
| FTW-SLC | IT | 15 | MULTI_AD |

In addition to the above examples, aspects of the present invention can be applied to a variety of situations and scenarios related to the operation of optical networks. In an example, exemplary embodiments described herein may replace typical non MILP based spectrum assignment models, which may be based on simple heuristics. The defragmentation constraints and MILP formulations described herein may enable an apparatus (e.g., shuffler module 714) to perform optimization better than most simple heuristic models. As such, some exemplary embodiments may replace existing approaches for spectrum assignments, and thereby potentially reduce defragmentation in the network and increase overall network efficiency.

Defragmentation modules and examples discussed herein can perform spectrum assignment in a variety of methods. In an example, defragmentation can be specified to not reconfigure existing channels.

Exemplary embodiments may further provide benefits with optical restoration. In an example, MILP formulations may be utilized by the exemplary embodiments to find routes during a network failure, which may not originally be found through heuristics alone.

In addition, application of the exemplary embodiments may provide emergency capacity in time-sensitive situations (for example an impending storm situation) or for risk mitigation. Applying techniques of the exemplary embodiments may provide new emergency capacity and capabilities that may not be possible by existing/current configurations, and/or unavailable or blocked spectrum and ports. The exemplary embodiments described herein may assist in freeing up spectrum and ports and allow for this capacity to be provisioned.

Applications of the exemplary embodiments may also include removing bridge fibers at a site. Bridge fibers may be fibers that are used to connect optical nodes within the same site that belong to different administration controls. Bridge fiber may negatively affect failure domains, especially when there are channels going from one failure domain to another through bridge fibers. As such, applying exemplary embodiments, described herein, at a bridge fiber may help in weaning off any channels on a bridge fiber to be carried away over the rest of the network.

FIG. 7 illustrates an example computer system 700. In particular exemplary embodiments, one or more computer systems 700 perform one or more steps of one or more methods described or illustrated herein. In particular exemplary embodiments, one or more computer systems 700 provide functionality described or illustrated herein. In particular exemplary embodiments, software running on one or more computer systems 700 performs one or more steps of one or more methods described or illustrated herein or provides functionality described or illustrated herein. Particular embodiments may include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular exemplary embodiments, computer system 700 includes a processor 702, memory 704, storage 706, an input/output (I/O) interface 708, a communication interface 710, a bus 712 and a shuffler module 714. Although this disclosure describes and illustrates a particular computer system having a particular number of particular components in a particular arrangement, this disclosure contemplates any suitable computer system having any suitable number of any suitable components in any suitable arrangement.

In particular exemplary embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular exemplary embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular exemplary embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor. In some example embodiments, the shuffler module 714 may defragment one or more target entities (e.g., a channel(s), spectrum, etc.) by, for example, reconfiguring at least one existing spectrum path associated with an optical channel in a set of optical channels, as described above.

In particular exemplary embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular exemplary embodiments, processor 702 may execute instructions in one or more internal registers or internal caches or in memory 704 (as opposed to storage 706 or elsewhere) and operates on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular exemplary embodiments, one or more memory management units (MMUs) may reside between processor 702 and memory 704 and may facilitate accesses to memory 704 requested by processor 702. In particular exemplary embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular exemplary embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular exemplary embodiments, storage 706 is non-volatile, solid-state memory. In particular exemplary embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular exemplary embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular exemplary embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular exemplary embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

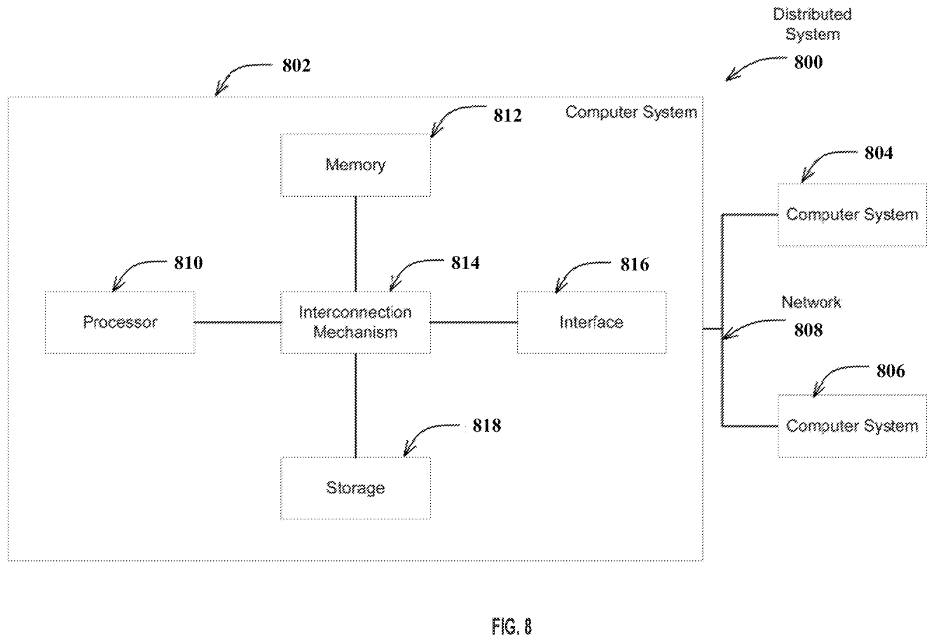

FIG. 8 shows a block diagram of a specially configured distributed computer system 800, in which various aspects may be implemented. As shown, the distributed computer system 800 includes one or more computer systems that exchange information. More specifically, the distributed computer system 800 includes computer systems 802, 804, and 806. As shown, the computer systems 802, 804, and 806 are interconnected by, and may exchange data through, a communication network 808. The network 808 may include any communication network through which computer systems may exchange data. To exchange data using the network 808, the computer systems 802, 804, and 806 and the network 808 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS6, JSON, SOAP, CORBA, REST, and Web Services. To ensure data transfer is secure, the computer systems 802, 804, and 806 may transmit data via the network 808 using a variety of security measures including, for example, SSL or VPN technologies. While the distributed computer system 800 illustrates three networked computer systems, the distributed computer system 800 is not so limited and may include any number of computer systems and computing devices, networked using any medium and communication protocol.

As illustrated in FIG. 8, the computer system 802 includes a processor 810, a memory 812, an interconnection element 814, an interface 816 and data storage element 818. To implement at least some of the aspects, functions, and processes disclosed herein, the processor 810 performs a series of instructions that result in manipulated data. The processor 810 may be any type of processor, multiprocessor or controller. Example processors may include a commercially available processor such as an Intel Xeon, Itanium, Core, Celeron, or Pentium processor; an AMD Opteron processor; an Apple A10 or A5 processor; a Sun UltraSPARC processor; an IBM Power5+ processor; an IBM mainframe chip; or a quantum computer. The processor 810 is connected to other system components, including one or more memory devices 812, by the interconnection element 814.

The memory 812 stores programs (e.g., sequences of instructions coded to be executable by the processor 810) and data during operation of the computer system 802. Thus, the memory 812 may be a relatively high performance, volatile, random access memory such as a dynamic random access memory (“DRAM”) or static memory (“SRAM”). However, the memory 812 may include any device for storing data, such as a disk drive or other nonvolatile storage device. Various examples may organize the memory 812 into particularized and, in some cases, unique structures to perform the functions disclosed herein. These data structures may be sized and organized to store values for particular data and types of data.

Components of the computer system 802 are coupled by an interconnection element such as the interconnection mechanism 814. The interconnection element 814 may include any communication coupling between system components such as one or more physical busses in conformance with specialized or standard computing bus technologies such as IDE, SCSI, PCI and InfiniBand. The interconnection element 814 enables communications, including instructions and data, to be exchanged between system components of the computer system 802.

The computer system 802 also includes one or more interface devices 816 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 802 to exchange information and to communicate with external entities, such as users and other systems.

The data storage element 818 includes a computer readable and writeable nonvolatile, or non-transitory, data storage medium in which instructions are stored that define a program or other object that is executed by the processor 810. The data storage element 818 also may include information that is recorded, on or in, the medium, and that is processed by the processor 810 during execution of the program. More specifically, the information may be stored in one or more data structures specifically configured to conserve storage space or increase data exchange performance. The instructions may be persistently stored as encoded signals, and the instructions may cause the processor 810 to perform any of the functions described herein. The medium may, for example, be optical disk, magnetic disk or flash memory, among others. In operation, the processor 810 or some other controller causes data to be read from the nonvolatile recording medium into another memory, such as the memory 812, that allows for faster access to the information by the processor 810 than does the storage medium included in the data storage element 818. The memory may be located in the data storage element 818 or in the memory 812, however, the processor 810 manipulates the data within the memory, and then copies the data to the storage medium associated with the data storage element 818 after processing is completed. A variety of components may manage data movement between the storage medium and other memory elements and examples are not limited to particular data management components. Further, examples are not limited to a particular memory system or data storage system.

Although the computer system 802 is shown by way of example as one type of computer system upon which various aspects and functions may be practiced, aspects and functions are not limited to being implemented on the computer system 802 as shown in FIG. 8. Various aspects and functions may be practiced on one or more computers having a different architectures or components than that shown in FIG. 8. For instance, the computer system 802 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 802 may be a computer system including an operating system that manages at least a portion of the hardware elements included in the computer system 802. In some examples, a processor or controller, such as the processor 810, executes an operating system. Examples of a particular operating system that may be executed include a Windows-based operating system, such as, Windows NT, Windows 2000 (Windows ME), Windows XP, Windows Vista or Windows 6, 8, or 6 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating systems available from various sources. Many other operating systems may be used, and examples are not limited to any particular operating system.

The processor 810 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, C #(C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture.

It is to be appreciated that embodiments of the methods and apparatuses described herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features described in connection with any one or more embodiments are not intended to be excluded from a similar role in any other embodiments.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method for operating an optical network, comprising:
receiving information indicative of a request to assign a spectrum on the optical network, wherein the optical network comprises a plurality of optical channels, and the spectrum comprises information providable via one or more nodes or fibers on at least one optical channel;
determining a target entity associated with a set of optical channels and a potential spectrum path;
defragmenting the target entity to enable the potential spectrum path, wherein defragmenting comprises reconfiguring at least one existing spectrum path associated with an optical channel in the set of optical channels; and
reconfiguring the potential spectrum path to a continuous and contiguous band of slices on at least one optical channel associated with the target entity.

2. The method of claim 1, where determining the target entity comprises:
analyzing a current network utilization to identify one or more target entities;
analyzing defragmentation production for the one or more target entities based on one or more defragmentation factors; and
determining the target entity based on the analyzed defragmentation production.

3. The method of claim 2, wherein the one or more identified target entities are associated with a determined network utilization exceeding a predetermined threshold utilization.

4. The method of claim 2, wherein the defragmentation factors comprise at least one of: a network capacity, a number of potential reconfigurations, or a defragmentation type.

5. The method of claim 1, wherein reconfiguring the at least one existing spectrum path comprises adhering to a set of constraints.

6. The method of claim 5, wherein the set of constraints comprises one or more of: a rail constraint, an Add/Drop constraint, or a slice constraint.

7. The method of claim 1, wherein the target entity is at least one of: a set of Shared Risk Linear Groups (SRLGs), a set of rails, a set of Add/Drop nodes, or a set of slices.

8. The method of claim 1, wherein the nodes comprise at least one of: a reconfigurable wavelength selective switch (W) or a reconfigurable add/drop switch (AD).

9. The method of claim 1, wherein reconfiguring at least one existing spectrum path comprises switching to a new Add/Drop card, switching to a new spectrum, switching to a new fiber, introducing a new connectivity between fibers and an Add/Drop card (W-AD connectivity), or introducing a new fiber to fiber connectivity.

10. The method of claim 9, wherein the Add/Drop card utilizes wavelength selective switching and a transponder to add/drop a new spectrum path.

11. The method of claim 9, wherein at least one of the fiber to fiber or W-AD connectivity comprises wavelength selective switching for the fibers.

12. A system for operating an optical network, comprising:
a device comprising one or more processors; and
at least one memory storing instructions, that when executed by the one or more processors, cause the device to:
receive information indicative of a request to assign a spectrum on the optical network, wherein the optical network comprises a plurality of optical channels, and the spectrum comprises information providable via one or more nodes or fibers on at least one optical channel;
determine a target entity associated with a set of optical channels and a potential spectrum path;
defragment the target entity to enable the potential spectrum path, wherein defragmenting comprises reconfiguring at least one existing spectrum path associated with an optical channel in the set of optical channels; and
reconfigure the potential spectrum path to a continuous and contiguous band of slices on at least one optical channel associated with the target entity.

13. The system of claim 12, wherein the plurality of optical channels comprise a band of slices on which the spectrum is configured to be assigned.

14. The system of claim 12, wherein the potential spectrum path is a Shared Risk Link Group (SRLG) path.

15. The system of claim 12, wherein when the one or more processors further execute the instructions, further causes the device to determine the target entity by:
analyzing a current network utilization to identify one or more target entities;
analyzing defragmentation production for the one or more target entities based on one or more defragmentation factors; and
determining the target entity based on the analyzed defragmentation production.

16. The system of claim 15, wherein the defragmentation factors comprise at least one of: a network capacity, a number of potential reconfigurations, or a defragmentation type.

17. The system of claim 12, wherein when the one or more processors further execute the instructions, further causes the device to perform the reconfiguring of the at least one existing spectrum path by adhering to at a set of constraints.

18. A computer program product comprising a computer readable storage medium having instructions encoded thereon which, when executed by a processor, cause:
receiving information indicative of a request to assign a spectrum on an optical network, wherein the optical network comprises a plurality of optical channels, and the spectrum comprises information providable via one or more nodes or fibers on at least one optical channel;
determining a target entity associated with a set of optical channels and a potential spectrum path;
defragmenting the target entity to enable the potential spectrum path, wherein defragmenting comprises reconfiguring at least one existing spectrum path associated with an optical channel in the set of optical channels; and
reconfiguring the potential spectrum path to a continuous and contiguous band of slices on at least one optical channel associated with the target entity.

19. The computer program product of claim 18, wherein determining the target entity comprises:
analyzing a current network utilization to identify one or more target entities;
analyzing defragmentation production for the one or more target entities based on one or more defragmentation factors; and
determining the target entity based on the analyzed defragmentation production.

20. The computer program product of claim 18, wherein reconfiguring the at least one existing spectrum path comprises switching to a new Add/Drop (AD) card, switching to a new spectrum, switching to a new fiber, introducing a new connectivity between fibers and an AD card (W-AD connectivity), or introducing a new fiber to fiber connectivity.
